(19) United States
(12) Patent Application Publication
(10) Pub. No.: US 2012/0219411 A1
(43) Pub. Date: Aug. 30, 2012

(54) TWO-STAGE CENTRIFUGAL PUMP

(75) Inventors: Bernd Hein, Baiersbronn/Schoenmuenzach (DE); Christoph Heier, Iffezheim (DE); Jerome Thiery, Strasbourg (FR)

(73) Assignee: ROBERT BOSCH GMBH, Stuttgart (DE)

(21) Appl. No.: 13/393,564

(22) PCT Filed: Jul. 13, 2010
(86) PCT No.: PCT/EP10/60007

§ 371 Date: May 15, 2012

(30) Foreign Application Priority Data
Sep. 1, 2009 (DE) 10 2009 029 069.9

(51) Int. Cl. F04D 17/08; B23P 15/00

(52) U.S. Cl. 415/208.1; 29/592.1

(57) ABSTRACT

The invention relates to a centrifugal pump (100), in particular for a coolant in a motor vehicle, comprising a first centrifugal pump stage (102) having a first pump housing (108), and a first impeller (110) rotatably mounted therein, and to a drive device (106) for coaxially driving the first impeller. A second centrifugal pump stage (104) has a second pump housing (114) and a second impeller (116) rotatably mounted therein and an intermediate housing (120) is located between the first and the second pump housing (108, 114) for diverting a fluid flow dispersed by the first impeller to an inlet region of the second impeller.

### BACKGROUND OF THE INVENTION

The invention relates to a centrifugal pump. In particular, the invention relates to a two-stage centrifugal pump for a coolant in a motor vehicle.

Single-stage centrifugal pumps, for example for conveying a coolant, are known in various variations. For example, EP 1850448 A1 shows a single-stage centrifugal pump in which a rotor of an electric motor driving the centrifugal pump is designed to be integrated with an impeller of the centrifugal pump.

In complex environments such as in a motor vehicle, varying requirements are placed on a centrifugal pump. For example, modern motor vehicles comprise diverse additional cooling circuits, for example for intake air cooling or for cooling electronic modules, which can require a higher build-up of pressure with the same or lower delivery volume as compared with a centrifugal pump used in a main cooling circuit. A single-stage centrifugal pump in principle suitable for these requirements, with a higher capacity than the main centrifugal pump, is usually substantially more expensive and has a larger external diameter, so that it cannot as readily be fitted in the motor vehicle as the main centrifugal pump.

### SUMMARY OF THE INVENTION

It is therefore an object of the invention to specify a centrifugal pump which, with the same build-up of pressure, has compact external dimensions and is simple to assemble.

According to a first aspect of the invention, a centrifugal pump, in particular for a coolant in a motor vehicle, comprises a first centrifugal pump stage having a first pump housing and a first impeller rotatably arranged therein, a drive device for the coaxial drive of the first impeller, a second centrifugal pump stage having a second pump housing and a second impeller rotatably arranged therein, and an intermediate housing arranged between the first and the second pump housing for deflecting a liquid stream discharged from the first impeller to an inlet region of the second impeller.

By using a two-stage centrifugal pump, the liquid to be conveyed can firstly be conveyed in the first centrifugal pump stage and then placed under increased pressure in the second centrifugal pump stage. In this way, an increased pressure elevation with respect to a single-stage centrifugal pump can be implemented with a constant external diameter, so that an existing installation space can be used unchanged and, if necessary, fixing elements such as a rubber sleeve can be incorporated unchanged. The intermediate housing can comprise deflection elements which deflect the liquid stream from an outflow region of the first impeller that is remote from the axis to an inlet region of the second impeller that is close to the axis. The deflection elements can, for example, run in a sickle shape toward a common axis of rotation of both impellers.

The intermediate housing can be connected integrally to the second pump housing. Integrity permits a corrosion-resistant and therefore rugged and long-lasting connection. The connection can be made, for example, by means of adhesive bonding, laser welding, ultrasonic welding, hot stamping or another known type of connection. In a further embodiment, the intermediate housing can also be connected to the first pump housing. Furthermore, the intermediate housing can also be connected to one of the two pump housings in an only force-fitting manner by means of any desired known technique. The connection produces a unit that can be handled separately, which may be advantageous when assembling the centrifugal pump.

The pump housings of the centrifugal pump can adjoin each other, and the intermediate housing can be accommodated in the first pump housing. The intermediate housing can occupy a space in the first pump housing which is provided in a similar way in the second pump housing and is filled there, for example, by a section of the adjacent drive device. Thus, the two pump housings can have internal geometries which are similar or identical in some sections, which can reduce fabrication costs.

The drive device can comprise a bearing pin and a rotor with a drive sleeve rotatably mounted on the bearing pin, to which the second impeller is connected in a torque-transmitting manner. The bearing pin can be arranged to be rotationally fixed with respect to a stator of the drive device. In this way, the second impeller does not have to be produced in a manner integrated with the rotor but can be connected to the rotor in a torque-transmitting manner only within the context of pre-assembly or final assembly. Furthermore, the first impeller can also be rotatably arranged on the bearing pin, so that axial alignment of the drive device and both impellers is ensured by means of the bearing pin.

The first impeller can be connected to the drive sleeve in a torque-transmitting manner by means of a driver geometry. The driver geometry can, for example, comprise interengaging crown-like contours on adjacent end faces of the drive sleeve and of the first impeller. The driver geometry can be formed in such a way that the first impeller can be brought into engagement with the drive sleeve without expenditure of force, so that an assembly operation has no influence on the precision of the arrangement.

The first impeller can also be connected to the second impeller in a torque-transmitting manner by means of a driver geometry.

The first centrifugal pump stage, the second centrifugal pump stage and the drive device can be arranged axially one after another, and the first pump housing can comprise an intake spigot leading to an inlet region of the first impeller that is close to the axis. As a result, in particular a section of the two-stage centrifugal pump that faces away from the drive unit can be formed as in the single-stage centrifugal pump, so that interchangeability is made easier.

A gap region between the rotating first impeller and the first pump housing can correspond to a gap region between the rotating second impeller and the second pump housing, so that the second impeller can be inserted into the first pump housing instead of the first impeller, in order to form a single-stage centrifugal pump. During fabrication of centrifugal pumps on a partly or fully automated production line, it is thus possible to change between the production of single-stage centrifugal pumps and two-stage centrifugal pumps with manageable conversion expenditure.

According to a second aspect of the invention, a method for assembling the above-described two-stage centrifugal pump comprises steps of pushing the second impeller onto the drive sleeve of the rotor, placing the second pump housing with the intermediate housing on the drive device, pushing the first impeller onto the bearing pin and placing the first pump housing on the second pump housing.

As a result of the chosen structure of the centrifugal pump, its final assembly comprises only a few operations that can be carried out with low requirements, for example on precision, expenditure of force and speed.

The method can also comprise the prior step of connecting the intermediate housing to the second pump housing. In this way, a unit that can be handled separately is produced, which further simplifies the assembly method. Optionally, the second impeller can also already previously be joined to the drive sleeve and the rotor of the drive device to form a unit that can be handled separately.

### BRIEF DESCRIPTION OF THE DRAWINGS

The invention will now be described with reference to the appended drawings, in which:

FIG. 1 shows a longitudinal section through a two-stage centrifugal pump;

FIG. 2 shows an isometric view of the second pump housing with the intermediate housing from FIG. 1;

FIG. 3a shows a torque-transmitting connection of the first impeller to the second impeller in FIG. 1;

FIG. 3b shows a variation of the connection from FIG. 3a; and

FIG. 4 shows a method for assembling the centrifugal pump from FIG. 1.

### DETAILED DESCRIPTION

Identical or mutually corresponding elements bear the same designations in all the figures.

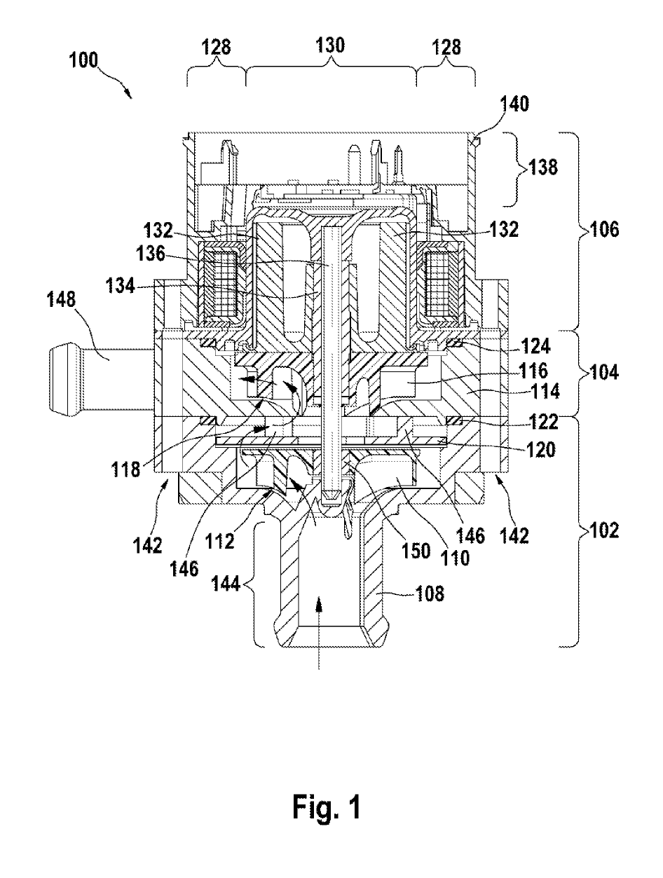

FIG. 1 shows a longitudinal section through the centrifugal pump 100. The centrifugal pump 100 comprises a first pump stage 102, a second pump stage 104 and an electric motor 106 as drive device. The first pump stage 102 comprises a first pump housing 108 and a first impeller 110, between which a first gap region 112 is formed. The second pump stage 104 comprises a second pump housing 140 and a second impeller 116, between which a second gap region 118 is formed. In a region between the first pump stage 102 and the second pump stage 104 there is arranged an intermediate housing 120. The first pump housing 108 rests on the second pump housing 114 and is sealed off with respect to the latter by means of an O-ring 122. The second pump housing 114 rests on the electric motor 106 and is sealed off with respect to the latter in a corresponding way by means of an O-ring 124.

The electric motor 106 comprises a stator 128, a rotor 130 having permanent magnets 132, also a drive sleeve 134, a bearing pin 136, an electric control device 138 and a housing 140. Bolt channels 142 run through the first pump housing 108, the second pump housing 114 and the housing 140 of the electric motor 106, in order in each case to accommodate bolts (not illustrated) which hold the centrifugal pump 100 together.

A flow direction of a liquid through the centrifugal pump 100 is indicated by means of arrows. The liquid enters at the bottom through an intake spigot 144 formed on the first pump housing 108 and then reaches an inlet region of the first impeller 110 that is close to the axis. The impeller 110 rotates about the bearing pin 136 during operation, so that the liquid is accelerated in the radial direction and is discharged outward. On its left-hand side, the intermediate housing 120 has a cut-out, through which the liquid discharged rises and flows along deflection elements 146 of the intermediate housing 120 toward the bearing pin 136. From there, the liquid passes further upward into an inlet region of the second impeller 116 that is close to the axis. During operation, said impeller 116 likewise rotates about the bearing pin 136, so that the liquid is again accelerated in the radial direction and is discharged outward. The second pump housing 114 has a larger internal diameter than the external diameter of the second impeller 116, so that a radial interspace is formed, along which the liquid discharged flows in the direction of a pressure spigot 148 which is formed on the circumference of the second pump housing 114 and through which the liquid finally leaves the centrifugal pump 100.

At its upper end, the bearing pin 136 is rotationally fixedly accommodated in a section of the stator 128, for example by means of a press or fit connection. Rotatably arranged on the bearing pin 136 is the drive sleeve 134, which is connected in a rotationally stable manner to the permanent magnets 132 and the second impeller 116. In order to fix the permanent magnets 132 to the drive sleeve 134, further components can be used, for example a magnet carrier (not shown). The latter can enclose the permanent magnets 132 in a liquid-tight manner. Apart from this, the liquid to be conveyed flows freely around the rotor 130. A position of the drive sleeve 134 on the bearing pin 136 at the top is bounded by the drive sleeve 134 resting on the stator 128.

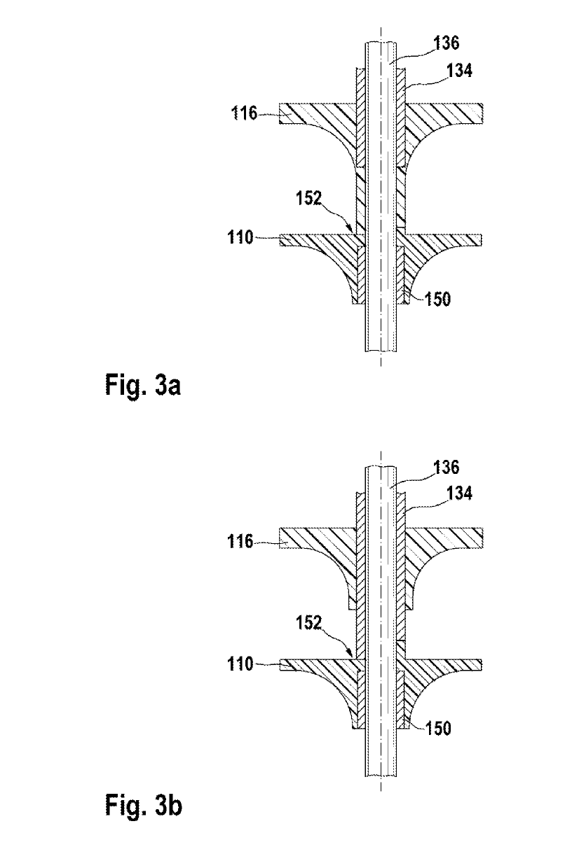

At its lower end, the bearing pin 136 is arranged in a receptacle formed on the first pump housing 108. The bearing pin 136 is chamfered at its lower end in order to facilitate its insertion into the receptacle. Above the receptacle, the first impeller 110 is arranged such that it can rotate about the bearing pin 136. For this purpose, between the first impeller 110 and the bearing pin 136 there is arranged a bearing bush 150, which is connected in a rotationally stable manner to the first impeller 110, for example by means of shrinking, pressing, adhesive bonding or injection molding on. A position of the first impeller 110 on the bearing pin 136 at the bottom is bounded by the first impeller 110 resting on the first pump housing 108. A device for transmitting torque from the second impeller 116 or the drive sleeve 134 to the first impeller 110, which also delimits the position of the first impeller 110 at the top and of the drive sleeve 134 at the bottom, is not illustrated in FIG. 1 and will be described extensively below with reference to FIGS. 3a and 3b.

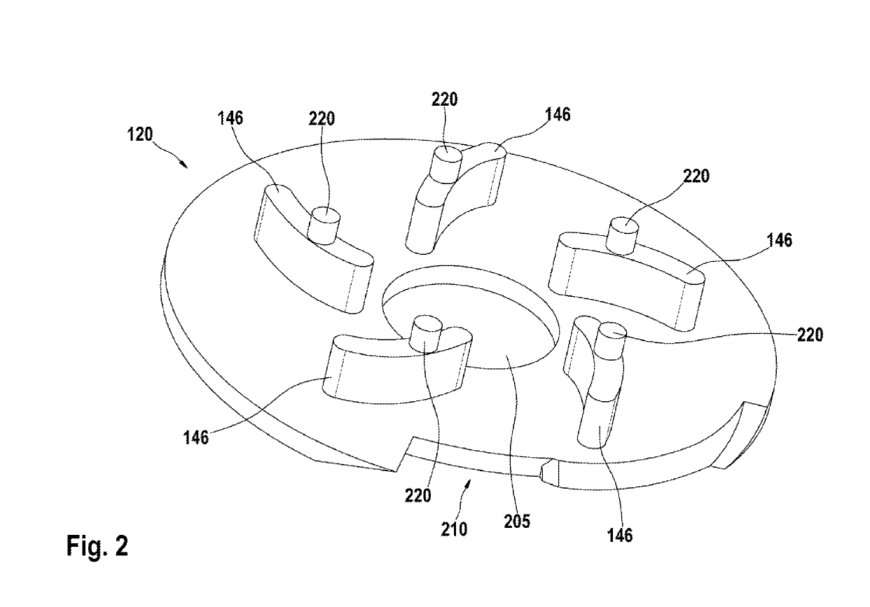

FIG. 2 shows an isometric illustration of the intermediate housing 120. In the middle, the intermediate housing 120 has a round central cut-out 205; in the front region a lateral cut-out 210 can be seen, through which the liquid can flow from the underside of the intermediate housing 120 to the deflection elements 146 in the region of the upper side of the intermediate housing 120. Arranged on an upper surface of the intermediate housing 120 are five sickle-like deflection elements 146, which run from a radius of the intermediate housing 120 to the central cut-out 205. The radius is chosen such that liquid can flow unimpeded around a radially outer region of the upper side of the intermediate housing 120.

Each deflection element 146 has a pin 220 on its upper side to engage in and optionally to be adhesively bonded to corresponding cut-outs in the second pump housing 114. In another embodiment, the pins 220 are missing and the intermediate housing 120 is adhesively bonded flat to the second pump housing 114 in the region of the deflection elements 146. Connecting the intermediate housing 120 to the second pump housing 114 produces a unit that can be handled separately.

FIG. 3a shows a device, not illustrated in FIG. 1, for transmitting torque between the first impeller 110 and the second impeller 116. The first impeller 110 is rotationally fixedly connected to the bearing bush 150, which is freely rotatably mounted on the bearing pin 136. As distinct from the illustration in FIG. 1, the bearing bush 150 runs through the first impeller only in a lower section.

The second impeller 116 is rotationally fixedly connected to the drive sleeve 134, which is freely rotatably mounted on the bearing pin 136. In the region of the bearing pin 136, the lower end of the second impeller is shaped so as to point sufficiently far downward that its lower end face adjoins the upper end face of the first impeller 110. As a result, a distance between the impellers 110 and 116 on the bearing pin 136 is restricted. In the region of the abutting end faces of the impellers 110 and 116 there is a crown profile 152, of which one peak can be seen on the right-hand side of the bearing pin 136. With the aid of the crown profile 152, the impellers 110 and 116 are connected to each other in a torque-stable manner. The interengaging flanks of the crown profile 152 can run around the bearing pin 136 in the form of a rectangle, trapezium or corrugation, and it is possible for one or more peaks to be enclosed by the crown profile 152. Adjacent flanks of the peaks can run in parallel or else at an angle to one another, so that a torque is preferably transmitted in a direction of rotation. As a result, assembly of the impellers 110 and 116 on each other can be made easier. In a further embodiment, it is also possible for a driver pin (not illustrated) parallel to the bearing pin 136 to engage in corresponding cut-outs in the impellers 110 and 116 and connect the latter to each other in a torque-transmitting manner.

FIG. 3b shows an alternative embodiment of the device shown in FIG. 3a for use in the centrifugal pump 100 from FIG. 1. The device corresponds substantially to that from FIG. 3a, with the difference that it is not the lower end face of the second impeller 116 but the lower end face of the drive sleeve 134 that engages with the upper end face of the first impeller 110 via the crown profile 152.

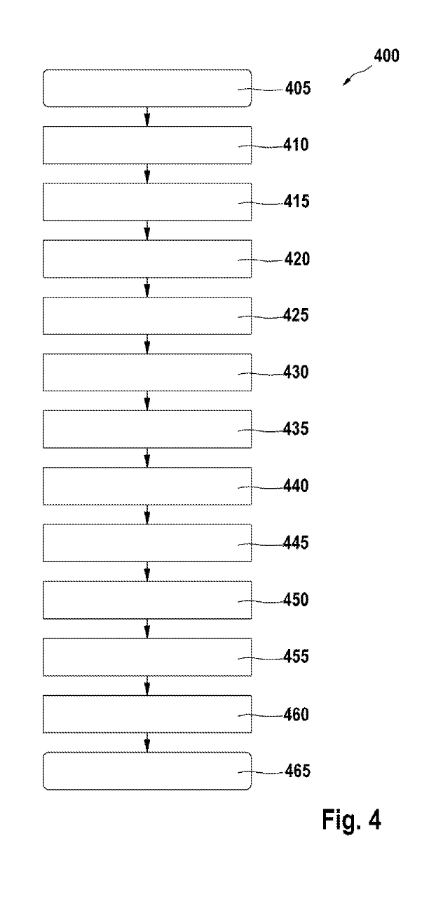

FIG. 4 shows a method 400 comprising steps 405 to 465 for the assembly of the centrifugal pump 100 from FIG. 1. In step 405, the method 400 is at the start. In the first step 410, the stator 128, together with the housing 140 and the control device 138, is oriented such that the bearing pin 136 points upward. Then, in step 415, the rotor 130 with the permanent magnets 132 is pushed onto the drive sleeve 134. After that, in step 420, the second impeller 116 is pushed onto the drive sleeve 134. The subassembly created in this way is pushed onto the bearing pin 136 in the following step 425 and lies on the stator 128 of the electric motor 106. After that, the second O-ring 124 is inserted into the second pump housing 114 and then, in step 435, the second pump housing 114 is placed on the electric motor 106.

Then, in step 440, the first impeller 110 is pushed onto the bearing pin 136. Then, in step 445, the first O-ring 122 is inserted into the first pump housing 108 and the first pump housing 108 is placed on the second pump housing 114 in step 450.

In the following steps 455 and 460, bolts are introduced into the bolt channels 142 and tightened, for example by screwing or riveting. After that, the method is at the end 465.

By means of the method 400, the centrifugal pump 100 can be assembled efficiently, higher forces having to be applied only in the steps 415 and 420, which can also be carried out separately, and in the final step 460. In intermediate stages between the method steps 405 to 465 of the method 400, elements of the pump 100 that have already been arranged on one another are held on one another by gravity, so that no holding or clamping devices are required. As a result of using a crown profile 152, the mounting of the movable components 110, 150, 116, 134 of the centrifugal pump 100 along the bearing pin 136 is defined and, at the same time, a torque flow to the first impeller 110 is produced without loading elements of the centrifugal pump 100 mechanically by the assembly operation.

1. A centrifugal pump (100), comprising:
a first centrifugal pump stage (102) having a first pump housing (108) and a first impeller (110) rotatably arranged therein
a drive device (106) for the coaxial drive of the first impeller (110);
a second centrifugal pump stage (104) having a second pump housing (114) and a second impeller (116) rotatably arranged therein; and
an intermediate housing (120) provided between the first and the second pump housing (114) for deflecting a liquid stream discharged from the first impeller (110) to an inlet region of the second impeller (116).

2. The centrifugal pump (100) as claimed in claim 1, characterized in that the intermediate housing (120) is connected integrally to the second pump housing (114).

3. The centrifugal pump (100) as claimed in claim 1, characterized in that the first and second pump housings (108, 114) adjoin each other, and in that the intermediate housing (120) is accommodated in the first pump housing (108).

4. The centrifugal pump (100) as claimed in claim 1, characterized in that the drive device (106) comprises a bearing pin (136) and a rotor (130) with a drive sleeve (134) rotatably mounted on the bearing pin (136), to which the second impeller (116) is connected in a torque-transmitting manner.

5. The centrifugal pump (100) as claimed in claim 4, characterized in that the first impeller (110) is connected to the drive sleeve in a torque-transmitting manner by means of a driver geometry (152).

6. The centrifugal pump (100) as claimed in claim 1, characterized in that the first impeller (110) is connected to the second impeller (116) in a torque-transmitting manner by means of a driver geometry (152).

7. The centrifugal pump (100) as claimed in claim 1, characterized in that the first centrifugal pump stage (102), the second centrifugal pump stage (104) and the drive device (106) are arranged one after another, and in that the first pump housing (108) comprises an intake spigot (108) leading to an inlet region of the first impeller (110) that is close to an axis.

8. The centrifugal pump (100) as claimed in claim 1, characterized in that a gap region (112) between the rotating first impeller (110) and the first pump housing (108) corresponds to a gap region (118) between the rotating second impeller (116) and the second pump housing (114), so that the second impeller (116) can be inserted into the first pump housing (108) instead of the first impeller (110), in order to form a single-stage centrifugal pump.

9. A method for assembling the centrifugal pump (100) as claimed in claim 4, characterized by the following steps:
pushing the second impeller (116) onto the drive sleeve (134) of the rotor;
placing the second pump housing (114) with the intermediate housing (120) on the drive device (106);
pushing the first impeller (110) onto the bearing pin (136); and
placing the first pump housing (108) on the second pump housing (114).

10. The method as claimed in claim 9, characterized by the prior step of connecting the intermediate housing (120) to the second pump housing (114).

11. The centrifugal pump (100) as claimed in claim 2, characterized in that the first and second pump housings (108, 114) adjoin each other, and in that the intermediate housing (120) is accommodated in the first pump housing (108).

12. The centrifugal pump (100) as claimed in claim 11, characterized in that the drive device (106) comprises a bearing pin (136) and a rotor (130) with a drive sleeve (134) rotatably mounted on the bearing pin (136), to which the second impeller (116) is connected in a torque-transmitting manner.

13. The centrifugal pump (100) as claimed in claim 12, characterized in that the first impeller (110) is connected to the drive sleeve in a torque-transmitting manner by means of a driver geometry (152).

14. The centrifugal pump (100) as claimed in claim 13, characterized in that the first impeller (110) is connected to the second impeller (116) in a torque-transmitting manner by means of a driver geometry (152).

15. The centrifugal pump (100) as claimed in claim 14, characterized in that the first centrifugal pump stage (102), the second centrifugal pump stage (104) and the drive device (106) are arranged one after another, and in that the first pump housing (108) comprises an intake spigot (108) leading to an inlet region of the first impeller (110) that is close to an axis.

16. The centrifugal pump (100) as claimed in claim 15, characterized in that a gap region (112) between the rotating first impeller (110) and the first pump housing (108) corresponds to a gap region (118) between the rotating second impeller (116) and the second pump housing (114), so that the second impeller (116) can be inserted into the first pump housing (108) instead of the first impeller (110), in order to form a single-stage centrifugal pump.
